(19) United States
(12) Patent Application Publication
(10) Pub. No.: US 2018/0231201 A1
(43) Pub. Date: Aug. 16, 2018

(54) LAMP INSERT AND METHOD OF USE

(71) Applicant: Operation 320, LLC, Weston, MO (US)

(72) Inventors: Katherine B. Heim, Weston, MO (US); Susan B. Hart, Weston, MO (US)

(21) Appl. No.: 15/895,412

(22) Filed: Feb. 13, 2018

Related U.S. Application Data
(60) Provisional application No. 62/458,332, filed on Feb. 13, 2017.

(51) Int. Cl. F21S 9/03; F21V 21/08; F21S 8/08; F21V 7/24

(52) U.S. Cl. CPC F21S 9/037; F21V 21/0824; F21W 2131/10; F21V 7/24; F21S 8/081

(57) ABSTRACT

A lamp system with an insert. The lamp portion includes an exterior lamp such as a solar-powered exterior lamp. These lamps are typically used for lighting pathways and the exterior of homes. The lamp insert is placed on the inside of the transparent cover of the lamp. The inserts are made of a flexible plastic with a reflective foil backing. The coating can be colored or include patterns. Cut-outs within the insert allow light to shine out of the lamp in patterns, which can be general patterns such as stars or shapes, to more specific patterns themed after holidays or other events

### CROSS-REFERENCE TO RELATED APPLICATION

This application claims priority in U.S. Provisional Patent Application No. 62/458,332 Filed Feb. 13, 2017, which is incorporated herein by reference.

### BACKGROUND OF THE INVENTION

### 1. Field of the Invention

The present invention relates generally to lamp insert and method for use thereof, and more specifically to a lamp insert with patterns and cutouts for use with a lamp or other light source.

### 2. Description of the Related Art

Decorating lamps or using light fixtures as ornamental decorations for holidays or other events is prevalent. However, the typical method of providing such ornamentation is by replacing or covering the outside of the light source with a translucent shell or cover. This changes the dimensions of the light source and is simply not practical in all situations.

Heretofore there has not been available a system or method for a lamp insert with the advantages and features of the present invention.

### BRIEF SUMMARY OF THE INVENTION

The present invention generally provides a lamp insert for inserting into a light source, such as a solar-powered exterior lamp. These lamps are typically used for lighting pathways and the exterior of homes. The lamp insert is placed on the inside of the transparent cover of the lamp. The inserts are made of a flexible plastic with a reflective foil backing. The coating can be colored or include patterns. Cut-outs within the insert allow light to shine out of the lamp in patterns, which can be general patterns such as stars or shapes, to more specific patterns themed after holidays or other events.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention.

FIG. 2 is a partially exploded three-dimensional isometric view thereof.

FIG. 3 is a three-dimensional isometric view showing elements in more detail.

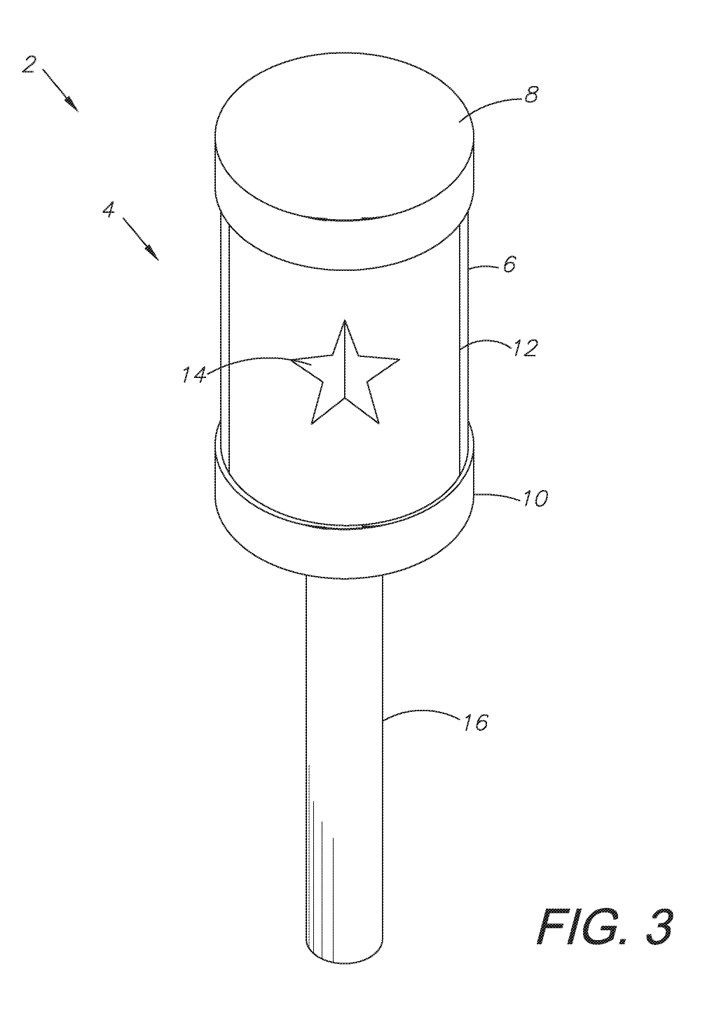

FIG. 4 is a partially exploded three-dimensional isometric view showing a ground stake element being inserted into a stand element.

FIG. 5 is a front elevational view of an insert element thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

II. Preferred Embodiment Lamp System 2 with Insert 12

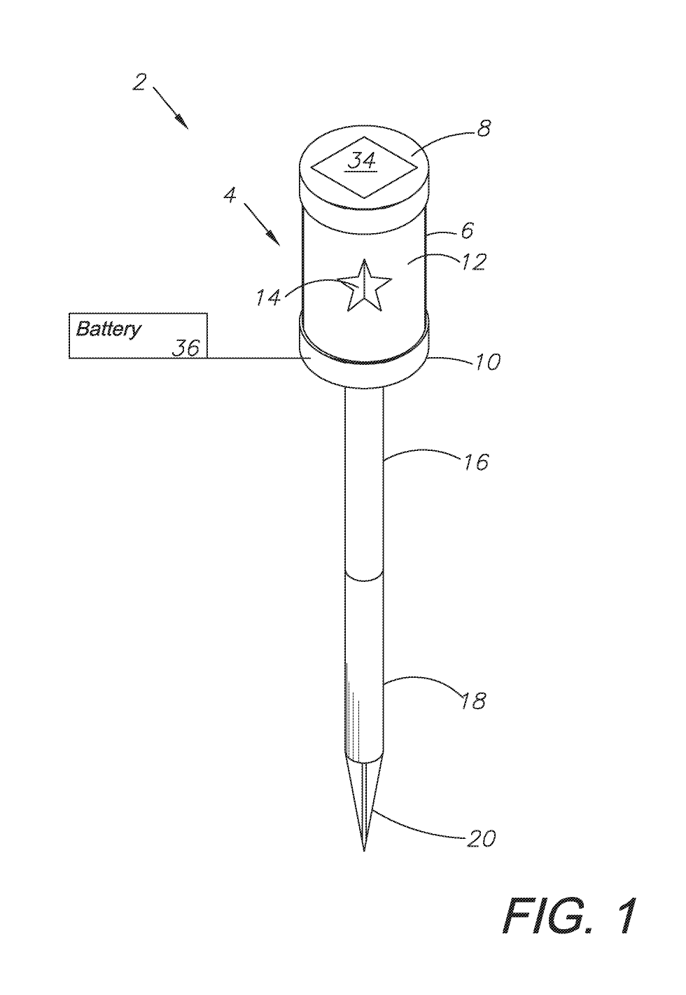

Referring to the figures in more detail, FIG. 1 shows a lamp system 2 which includes an upper lamp enclosure 4 and a lower ground stake element 18, where the stake element 18 interfaces with the upper lamp enclosure 4 via a stem 16 located affixed at the base 10 of the lamp enclosure 4. A cap 8 encloses the lamp enclosure. A glass or otherwise transparent screen 6 allows light out from the interior of the lamp enclosure 4, and a removable insert 12 placed within the lamp enclosure 4 behind the glass screen 6 includes at least one cutout portion 14 which allows light through.

The cap 8 may include a solar panel 34 for collecting solar power and for charging a battery 36 located either in the cap 8 or the base 10 for powering the light source 24.

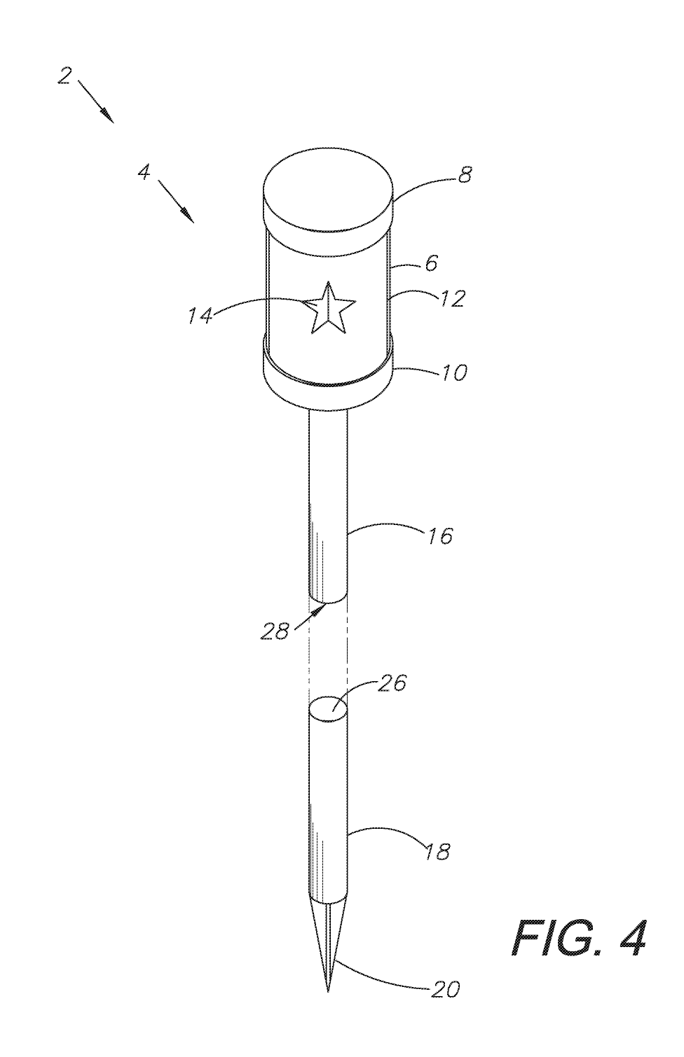

The stake portion 18 includes a tip 20 which allows the entire assembly to be inserted firmly into the ground to allow the lamp system 2 to be used to light outdoor spaces, such as paths and garden beds. FIG. 4 shows how the stake 18 top end 26 is received within the base 28 of the stem 16 of the upper lamp enclosure 4.

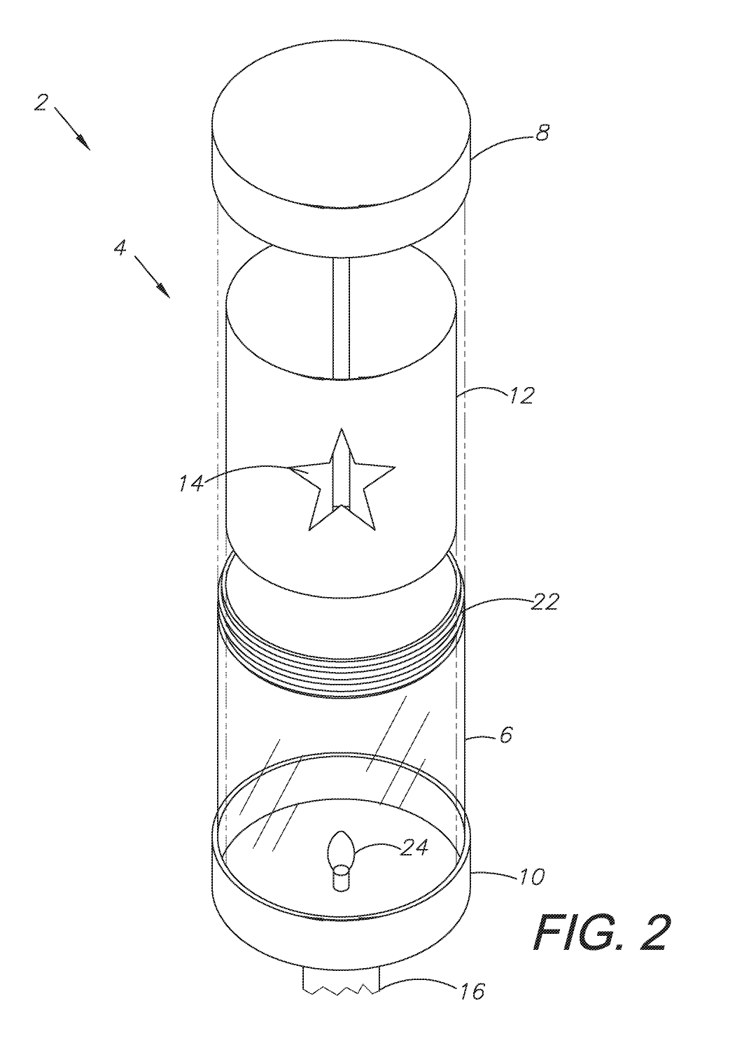

As shown in FIG. 2, the insert 12 surround the light source 24 within the lamp enclosure 4. The light source 24 is preferably a light bulb or light emitting diode (LED), but may be a candle flame as well. The cap 8 can be screwed onto the top of the glass screen 6 using a threaded connector 22. Other connection elements could also be used, such as a friction grip ring or some other suitable connector. This allows the insert to be interchanged at will.

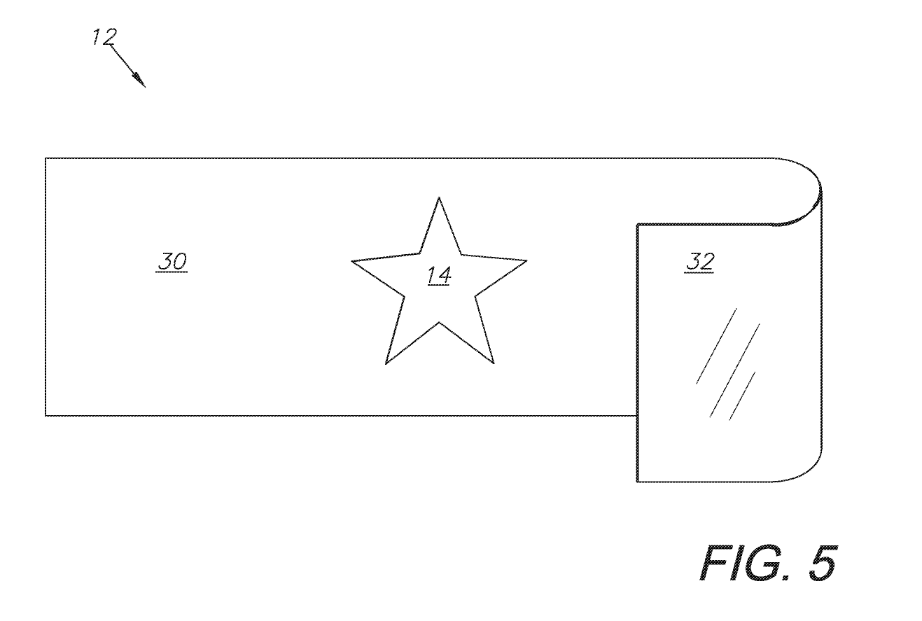

FIG. 5 shows the insert 12 in more detail, which features a front face 30, a rear face 32, and a cutout 14. The plastic front face 30 may be painted or otherwise decorated and can include patterns. The rear face 32 is a metallic foil which reflects light from the lamp when the insert is inserted into the lamp. Cutout patterns 14 allow light to escape the lamp through the insert 6.

As shown, the insert is placed within the transparent housing of the lamp, blocking the light from the light source within the lamp in all directions except through the cutout pattern. This retains the shape and silhouette of the lamp while adding a customizable, swappable lighting pattern for decorative purposes. Unlike existing light fixture decorations, this invention is inserted on the inside of the existing light source.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A lamp system comprising:
a lamp enclosure having an upper end enclosed by a removable cap, a lower end enclosed by a base, and a transparent screen forming a generally cylindrical space having an interior;
a flat flexible insert having a first face, a second face, and at least one cut-out portion, said flat flexible insert configured to be curled into a generally cylindrical shape and further configured to be inserted into said interior of said transparent screen generally cylindrical space;
a stem connected to said base, said stem having a receiver for receiving a top end of a ground stake;
said ground stake including a pointed end configured for being inserted into a ground surface; and
a light element located in proximity with said base and within said interior of said transparent screen, said light element configured to produce light which escapes through said cut-out portions of said flat flexible insert.

2. The lamp system of claim 1, wherein said first face of said flat flexible insert comprises a decorated surface.

3. The lamp system of claim 1, wherein said second face of said flat flexible insert comprises a reflective surface.

4. The lamp system of claim 1, wherein said removable cap further comprises a solar panel for receiving solar energy and converting said solar energy into electrical power.

5. The lamp system of claim 1, further comprising a battery power source for powering said light element.
